(19) United States
(12) Patent Application Publication
(10) Pub. No.: US 2018/0354089 A1
(43) Pub. Date: Dec. 13, 2018

(54) MACHINE TOOL FOR MACHINING A WORKPIECE

(71) Applicant: DECKEL MAHO Pfronten GmbH, Pfronten (DE)

(72) Inventors: Alfred Geissler, Pfronten (DE); Robert Jung, Pfronten (DE); Martin Rinderle, Buchenberg (DE); Florian Lau, Pfronten (DE)

(21) Appl. No.: 15/997,683

(22) Filed: Jun. 4, 2018

(30) Foreign Application Priority Data
Jun. 7, 2017 (DE) 10 2017 209 606.3

(51) Int. Cl. B23Q 39/02; B23Q 3/155; B23Q 7/04

(52) U.S. Cl. CPC B23Q 39/027; B23Q 2039/002; B23Q 7/046; B23Q 3/15513

(57) ABSTRACT

The present invention relates to a machine tool 100 for machining a workpiece 12 by means of a tool 22, which comprises a clamping means 11 for clamping the workpiece 12 and a support means 21 for receiving the tool 22, wherein the clamping means 11 is mounted on a spindle head of a clamping means-carrying work spindle 10 and the support means 21 is mounted on a spindle head of a support means-carrying work spindle 20, and the machine tool 100 is designed to position the two work spindles 10, 20 by means of numerically controllable axes in relation to one another in such a way that the workpiece 12, which is clamped in the clamping means 11, can be processed by the tool 22, which is received in the support means 21.

The present invention relates to a machine tool for machining a workpiece. The present invention also relates to a method for machining a workpiece by means of a tool in a machine tool according to the invention.

### BACKGROUND OF THE INVENTION

Machine tools serve to manufacture workpieces by means of tools, which are moved relative to one another on the basis of numerically controlled axes in accordance with a predetermined NC program.

In this connection, combinations of production processes have been established in particular in the field of general-purpose machines in the last few years in order to offer the user a wider range of manufacturing possibilities using a machine tool; e.g. the combination of a lathe and a milling machine.

Since it is not irrelevant for the two methods whether the tool is rotationally driven and the workpiece is stationary, as is customary in milling, or the tool is stationary and accordingly the workpiece is rotationally driven, as is the case in turning, the hitherto known machine tools must occasionally be adapted in various ways in order to be able to carry out the two manufacturing processes appropriately with one machine.

However, the resulting problems are that, above all, for a workpiece which is to be processed while turning and is clamped on a conventional machine table with controllable rotational axis, it is hardly possible to accelerate to speeds that are required for the rotary machining of the workpiece. The reason is that the controllable rotational axes of the machine tool, which are otherwise usually responsible for the relative positioning of tool and workpiece, are not designed for such high speeds.

This can lead to considerable losses as regards the quality of the finished workpiece if the workpiece is processed while rotating with an insufficient speed.

DE 10 2009 027 463 A1 already discloses a machine tool in which the clampings of workpiece and tool are reversed. In this case, the workpiece is clamped in the work spindle to drive it with the appropriately required speed and the tool processing the workpiece is mounted on the machine table. In addition, the workpiece can be introduced or exchanged in automatic fashion as a result of this clamping situation.

However, this causes the problem that, should the workpiece also be processed by milling in addition to a turning processing, both the workpiece and the tool would have to be re-clamped again (tool on the work spindle and workpiece on the machine table), as a result of which the machine tool would have to be set up again, thus markedly extending the entire processing period of such a workpiece.

Another problem is that, with respect to a manufacture which comprises a plurality of workpieces and is as fully automated as possible, the tools mounted on the machine table can only be exchanged in a fully automatic way to a limited extent with a few method steps. For this purpose, the machine table must usually be advanced into a position in which the employed tool can be removed and another tool can be inserted. However, the machine table with corresponding drives is most often a machine tool element which has a comparatively large net weight, such that rapid positioning is only possible with difficulty and therefore valuable manufacturing time is always lost in the automatic exchange of the tool.

### SUMMARY OF THE INVENTION

An object of the present invention is therefore to provide a machine tool for machining a workpiece, by means of which the above problems are avoided.

A further object of the present invention is to provide a method for machining a workpiece by means of a tool in a machine tool according to the invention.

These objects are achieved by a machine tool according to claim 1 and a method according to claim 13. The dependent claims relate to advantageous embodiments of the machine tool according to the invention and of the method according to the invention.

The inventive machine tool for machining a workpiece by means of a tool comprises a clamping means for clamping the workpiece and a support means for receiving the tool, the clamping means being mounted on a spindle head of a work spindle that carries a clamping means and the support means being mounted on a spindle head of a work spindle that carries the support means, and the machine tool is designed to position the two work spindles by means of numerically controllable axes in relation to one another in such a way that the workpiece clamped in the clamping means can be processed by the tool received in the support means.

In the machine tool according to the invention, the two spindles can be used in a highly flexible way and both hold the workpiece in a stationary position and rotationally drive it accordingly. The same, of course, can also be done with the tool, as a result of which it is possible to go back and forth between a milling process and a turning process in a minimum of time without having to re-clamp the workpiece. The additional advantage of this is that the reference points of the machine tool, which are important for the automated processing of the workpiece, are not lost at the workpiece and a new set up of the machine tool is not necessary.

This is particularly advantageous when the workpiece has to be processed from all sides, i.e. also from the clamped side. Here, the workpiece can be handed over to the other work spindle in automated fashion and the side of the workpiece clamped so far can then be processed by the work spindle that originally carried the workpiece.

The machine tool according to the invention also renders possible that the workpiece can also be handed over directly between the work spindles. In this connection, the design of a multi-axis machine tool can be used with advantage to bring e.g. the two work spindles into a coaxial alignment to each other and then guide the workpiece along the common spindle axis of the two work spindles and hand it over to the non-workpiece-carrying spindle in order that the workpiece can be clamped there by means of a clamping element, e.g. a chuck or jaw chuck.

In addition to the increased flexibility of the machine tool, which can be used for both processing by milling and processing by turning, the automation degree of the machine tool can further be increased since all sides of a workpiece can be processed in automated fashion without a skilled worker or machine operator having to manually re-clamp and again set up the machine within a single processing cycle.

The machine tool according to the invention can be advantageously developed in that the two work spindles are designed to carry both a support means for receiving a tool and a clamping means for clamping a workpiece.

Due to the use of e.g. standardized supports (e.g. a hollow shank taper, steep taper, etc.) it is possible that the work spindles can carry the most diverse support and clamping means for very diverse tools and workpieces, which additionally increases the flexibility of the machine tool.

The machine tool according to the invention can be advantageously developed in that the two work spindles can be positioned in relation to each other by in each case at least one rotational axis and at least one linear axis.

Furthermore, the machine tool according to the invention can be advantageously developed in that a first of the two work spindles can be positioned about a first rotational axis and along a first linear axis in relation to the second of the two work spindles, and the second work spindle can be positioned about a second rotational axis, which extends in parallel to the first rotational axis, and along a second linear axis and a third linear axis which extend both perpendicularly to each other and perpendicularly to the first linear axis.

Due to the division of the numerically controllable axes in the described way, the two work spindles can be positioned in relation to each other in many ways, such that even more complex workpieces can be processed in a single clamping. As a result of the parallel arrangement of the rotational axes of the two work spindles, the work spindles can also be positioned for changing the clamping and support means in such a way that e.g. an existing manipulator can be used for changing the clamping and support means.

In addition, the machine tool according to the invention can be advantageously developed in that the two work spindles are configured to adopt a basic position in which the spindle axes lie in a plane, wherein a coaxial arrangement of the two work spindles can be produced on the basis of the basic position by positioning the work spindles in relation to each other by a single rotary motion about a respective rotational axis perpendicular to the plane.

Since it is possible to coaxially align the work spindles, the workpiece can be handed over directly between the work spindles without having to provide an additional supply device for handing over the workpiece.

Furthermore, the machine tool according to the invention can be advantageously developed in that the machine tool also has a manipulator which is designed to introduce and exchange, on the two work spindles, both the workpiece-carrying clamping means and/or the non-workpiece-carrying clamping means and the tool-carrying support means and/or the non-tool-carrying support means.

Here, the manipulator can be used in a very flexible way for the two work spindles and can supply both clamping means and support means, which again can be or cannot be carrying a workpiece and/or can be or cannot be carrying a tool to the respective work spindle or can correspondingly exchange these means.

In addition, the machine tool according to the invention can be advantageously developed in that the machine tool also has a magazine which is configured to place down clamping means that carry or do not carry a workpiece as well as to place down support means that carry or do not carry a tool, the manipulator being also designed to remove the corresponding clamping or support means from the magazine.

Along with the manipulator, it is an advantage to provide a magazine for storing the corresponding clamping and support means, such that the manipulator can always operate between the work spindles and the magazine and, where necessary, can introduce or exchange the corresponding clamping and/or support means.

Furthermore, the machine tool according to the invention can be advantageously developed in that the machine tool has two magazines which are designed to place down clamping means that carry or do not carry a workpiece and to place down support means that carry or do not carry a tool and one or two manipulators, which are arranged on the work spindles in order to introduce and exchange clamping means that carry and/or do not carry a workpiece and support means that carry and/or do not carry a tool.

Another equally advantageous design is obtained if two manipulators and two magazines are provided. For example, a magazine can be assigned to each work spindle and one manipulator each can operate between the work spindle and its associated magazine. However, a kind of a cross-over operation of the manipulators can also be provided, such that the two manipulators can provide the two magazines and the two work spindles with clamping and support means and/or can change said means.

The machine tool according to the invention can be advantageously developed by designing the magazines as wheel magazines and the manipulators as double grippers.

This can be advantageous in particular if in an exchange or change event of the clamping and/or support means at the work spindles, during which one or more manipulators are actively used, the spindle axes are aligned in parallel to one another and in parallel to the clamping and/or support means of the corresponding wheel magazine that are to be introduced or exchanged.

As a result, the change or exchange event can take place very rapidly since the manipulator only needs a small number of travels and feed motions to get from the place at which it gathered the clamping or support means to be introduced to the spindle head where it suitably changes the clamping or support means.

This is additionally supported by designing the magazine as a wheel magazine since the clamping or support means to be introduced can always be moved from the wheel magazine to precisely the same handover position without having to use an additional manipulator or an additional supply device, as typical in the case of shelf magazines. Due to the design, they always require an additional device which transports the clamping or support means from the magazine to the handover position.

If the wheel magazine is additionally arranged in the machine tool in such a way that, at the handover position, the clamping or support means to be introduced is not only arranged in parallel to the manipulator or double gripper but also lies in the same horizontal plane as the clamping or support means of the corresponding work spindle, further travels and feed motions of the manipulator/double gripper can be avoided and thus change and exchange events can proceed more efficiently.

As a result, the machine tool according to the invention can be advantageously developed by arranging the spindle axis of the work spindles horizontally.

Furthermore, the machine tool according to the invention can be advantageously developed by arranging a first of the two work spindles on a console at the machine bed and arranging the second of the two work spindles on the machine bed such that it is guided on a cross table.

In this connection, the above mentioned arrangement of the work spindles is only an example and is not limited thereto. The work spindles can be aligned with a horizontal or vertical orientation and/or can be transferred from a horizontal orientation to a vertical one. The work spindles can also be arranged in another design of a machine tool (e.g. a console column-type design, cross table design, cross bed-type design or travelling column design).

Furthermore, the machine tool according to the invention can be advantageously developed in that the clamping means is an external clamping means or an internal clamping means.

Due to the use of both internal clamping means and external clamping means, a wide range of workpieces can be received by the work spindles and processed.

The inventive method for machining a workpiece by means of a tool in a machine tool according to the invention includes the following steps: clamping the workpiece in a clamping means which is mounted on a first work spindle, receiving the tool in a support means which is mounted on a second work spindle, processing a first side of the workpiece by means of the tool according to an NC program.

By means of the method according to the invention it is now possible to more effectively process the workpieces which shall be processed by both turning and milling since not only the tool and/or the workpiece can be fixed and also rotationally driven but also the tool can be changed rapidly and the workpiece can be handed over from one work spindle to next, such that the formerly clamped side of the workpiece can also be processed without a manual re-clamping having to be carried out.

The method according to the invention can be advantageously developed by the following step: exchanging the tool-carrying support means of the second work spindle and introducing a non-workpiece-carrying clamping means.

It is thus possible to provide a handover of the workpiece from the clamping means of one work spindle to the clamping means of the other work spindle. In this connection, different clamping means can be used, such as chucks or jaw chucks, internal or external clamping means, etc. For the exchange event, it is an advantage to use a manipulator, e.g. in the form of a double gripper or the like, to carry out the change in a suitably fast and automated way.

The method according to the invention can be advantageously developed by the following step: handing over the workpiece from the workpiece-carrying clamping means of the first work spindle to the non-workpiece-carrying clamping means of the second work spindle.

Due to the possibility of transferring the workpiece between the work spindles the workpiece can be handed over from one work spindle to the other and back within a single processing cycle. It is thus possible to program the machine tool with highly effective processing programs in such a way that it is possible to process the workpiece from all sides or within a shorter period since e.g. manual re-clamping is no longer necessary. For the handover process, it is also an advantage to use a manipulator, e.g. in the form of a double gripper or the like, to make the handover correspondingly fast and automatic.

In addition, the method according to the invention can be advantageously developed by the following steps: changing the non-workpiece-carrying clamping means of the first work spindle and introducing a workpiece-carrying support means, and processing a second side of the workpiece, which is opposite the already processed first side of the workpiece, by the tool which is received in the support means of the first work spindle, according to the NC program.

As a result, it is then possible to process the workpiece side that served as a clamping side while the other side of the workpiece was processed. It is thus possible to process a workpiece on all sides without requiring a manual re-clamping of the workpiece, which might possibly lead to a loss of the reference points of the machine tool on the workpiece and might then require a new set-up of the machine tool.

The method according to the invention can be advantageously developed in that, before the workpiece is handed over from the first work spindle to the second work spindle, the two work spindles adopt a coaxial arrangement in relation to each other.

The previous adoption of a coaxial alignment of the work spindles in relation to each other can here be a precondition for the direct transfer of the workpiece between the work spindles. This can become necessary e.g. if a turned part has to be re-clamped on the other work spindle to process the turned part on the formerly clamped side.

The method according to the invention can be advantageously developed by carrying out the following steps before the coaxial arrangement of the two work spindles is adopted: adopting a basic position in which the spindle axes lie in a plane and rotating the work spindles about a respective rotational axis perpendicular to the plane up to a coaxial alignment of the spindle axes of the two work spindles.

The basic position of the work spindles can also be used to exchange the clamping and support means on the work spindles (e.g. by means of a manipulator/double gripper). This can take place effectively in particular when the clamping and support means of the work spindles are positioned in parallel to the clamping and support means to be introduced of the corresponding magazine (e.g. wheel magazine).

The method according to the invention can be advantageously developed by handing over the workpiece from the first work spindle to the second work spindle in such a way that, during the handover, the two work spindles are in contact with the workpiece.

Since it is possible to transfer the workpiece directly between the spindles, the workpiece can be handed over more rapidly and an additional handover device can be omitted.

Furthermore, the method according to the invention can be advantageously developed by handing over the workpiece from the first work spindle to the second work spindle by means of a manipulator.

However, corresponding handover devices or supply devices can also be provided, e.g. in the form of a double gripper or the like, for transferring the workpiece between the spindles.

### BRIEF DESCRIPTION OF THE DRAWINGS

FIG. 1 shows, by way of diagram, the machine tool according to an embodiment with a machine bed and the work spindles which are mounted thereon and which can be positioned in relation to one another according to the illustrated three linear axes and two rotational axes;

FIG. 2 shows, by way of diagram, the machine tool in a further embodiment with two wheel magazines and two double grippers, wherein the work spindles are mounted on the machine bed of the machine tool and can be positioned in relation to one another in accordance with the numerically controllable axes from FIG. 1;

FIG. 3 shows, by way of diagram, the machine tool with two wheel magazines and two double grippers in a basic position of the work spindles;

FIG. 4 shows, by way of diagram, the handover of a workpiece between a first work spindle and a second work spindle according to an embodiment of the method according to the invention;

FIG. 5 shows a flow diagram of an embodiment of the method according to the invention.

### DETAILED DESCRIPTION OF THE DRAWINGS AND PREFERRED EMBODIMENTS OF THE PRESENT INVENTION

In the following, examples and/or embodiments of the present invention are described in detail with reference to the enclosed drawings.

However, it should be noted that the present invention is by no means limited or confined to the below described embodiments and the design features thereof but also comprises modifications of the embodiments, in particular those which are comprised by modifications of the features of the described examples and/or by combination of individual or a plurality of the features of the described examples on the basis of the scope of protection of the independent claims.

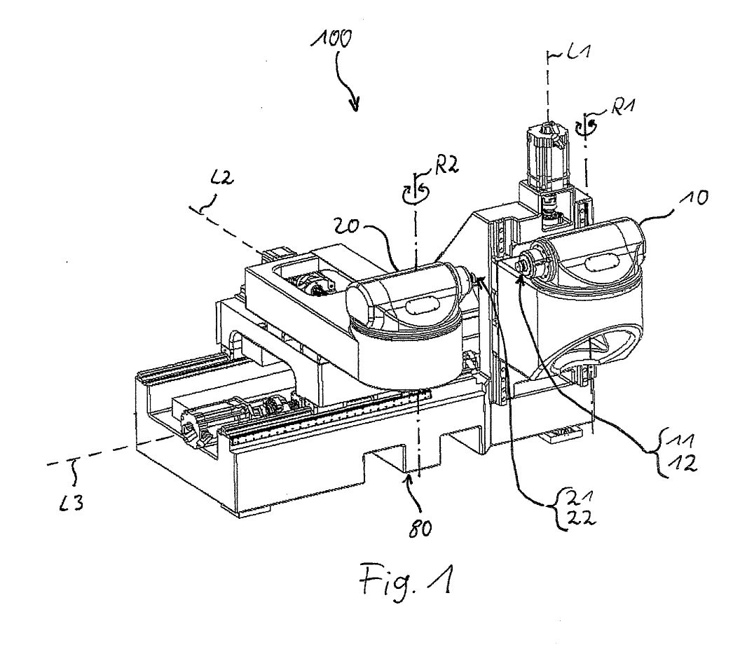

FIG. 1 shows, by way of diagram, the machine tool 100 with the machine bed 80 and the work spindles 10 and 20, which are mounted thereon and can be positioned in relation to one another according to the illustrated three linear axes L1, L2 and L3 and two rotational axes R1 and R2.

This embodiment concerns a machine tool 100, in which both the first work spindle 10 and the second work spindle 20 are mounted on the machine bed 80 in a kind of console design. However, it should be noted herein that the machine tool according to the invention is not limited to the described design. On the contrary, console designs and cross table designs and also column-type designs or the like as well as the most different combinations of said designs can be used.

The division of the numerically controllable axes of the machine tool 100 according to FIG. 1 is such that the first work spindle 10 can be moved vertically along the linear axis L1 and can be rotated about the rotational axis R1, which is parallel to the linear axis L1. The second work spindle 20 can be positioned horizontally in a plane by means of the linear axes L2 and L3, wherein the linear axis L3 positions the second work spindle 20 in the direction of the first work spindle 10 and L2 carries out the positioning perpendicular to the linear axes L1 and L3. The rotational axis R2, about which the second work spindle 20 can rotate, is here again in parallel to the rotational axis R1 of the first work spindle 10.

The advantage of this design now consists in that a machine table could fully be dispensed with and the fixation of the workpiece is such that it can also be subjected to a high and a partially very high speed to change from a milling processing to a turning processing in a minimum of time.

It should here be noted that in addition to the two work spindles a machine table can very well also be present or one of the two work spindles is a transportable work spindle which can be mounted/was mounted on the machine table. As a result, already existing machine tools might also be converted into a double spindle system.

In addition, FIG. 1 shows the two work spindles 10 and 20 in a coaxial alignment in relation to each other. This is not only relevant to the processing of the workpiece 12 but also to a handover of the workpiece 12 between the work spindles 10 and 20. Here, the workpiece 12, which is clamped in a clamping means 11 of the first work spindle 10, can be handed over to a clamping means 11 of the second work spindle 20 by positioning the second work spindle 20 in the plane of the linear axes L2 and L3 in relation to the first work spindle 10. If classical clamping means, such a chucks or jaw chucks, are used, the coaxial alignment of the two work spindles in relation to each other can be required in advance of the positioning movement of the work spindles.

FIG. 1 shows, in a concrete case, the coaxial alignment of the two work spindles 10 and 20 with a clamping means 11 and a workpiece 12 on the first work spindle 10 and a support means 21 with a tool 22 on the second work spindle 20.

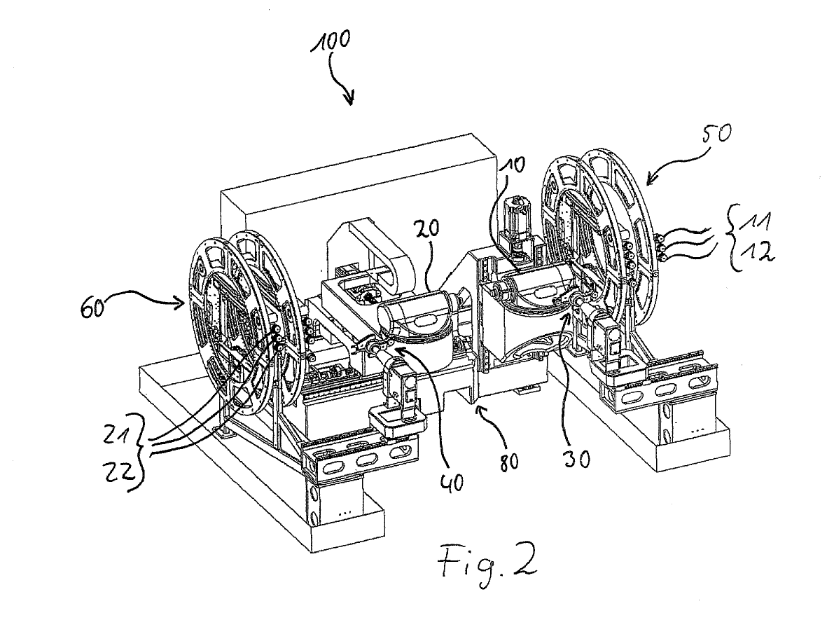

FIG. 2 shows, by way of diagram, the machine tool 100 in a further embodiment with two wheel magazines 50 and 60 and two double grippers 30 and 40, wherein the work spindles 10 and 20 are mounted on the machine bed 80 of the machine tool 100, said spindles being positionable in relation to each other in accordance with the numerically controllable axes from FIG. 1.

The extension of the machine tool 100 now lies in the wheel magazines 50 and 60 for storing and placing down tool-carrying support means and non-tool-carrying support means 21 and workpiece-carrying clamping means 11 and non-workpiece-carrying clamping means 11. In addition, the machine tool 100 differs in that it is equipped with double grippers 30 and 40 as manipulators to change and transport the clamping and support means 11 and 21 between the wheel magazines 50 and 60 and the work spindles 10 and 20 in a suitable way.

This relevantly favors a largely automated processing procedure of workpieces 12 since e.g. the blank of the workpiece 12 can be placed down in one of the wheel magazines 50 and 60 or can be removed from one of the wheel magazines 50 and 60. In addition, it is, of course, also possible to supply the finished workpiece 12 to the wheel magazines 50 and 60 again or to remove it therefrom. The intermediate steps in the processing of the corresponding workpiece 12 might be fully automated and in the ideal case would only require to be monitored but would not require any manual intervention by the skilled worker or the machine operator.

It is here noted that the double grippers 30 and 40 are not limited to interact in each case with only a single spindle 10 or 20 and/or a single wheel magazine 50 or 60. On the contrary, the machine tool 100 can be designed e.g. in such a way that the double grippers 30 and 40 can provide the two double spindles 10 and 20 and the two wheel magazines 50 and 60 with corresponding clamping and support means 11 and 21.

A further advantage in the illustrated design of the machine tool 100 is the selection of the magazines as wheel magazines 50 and 60. They are able to store tools 22 and workpieces 12 of various sizes by the clamping or support means 11 and 21 and to always take them by means of a rotary motion to the same handover position at which a double gripper 30 or 40 or another tool or workpiece changer can receive the corresponding clamping or support means 11 and 21. The major advantage e.g. in comparison with shelf storage areas is that an additional supply device can be dispensed with which first removes the corresponding clamping or support means 11 or 21 from the shelf storage area and takes it to the handover position of the double gripper 30 or 40, which receives the corresponding means and supplies it to one of the work spindles 10 or 20.

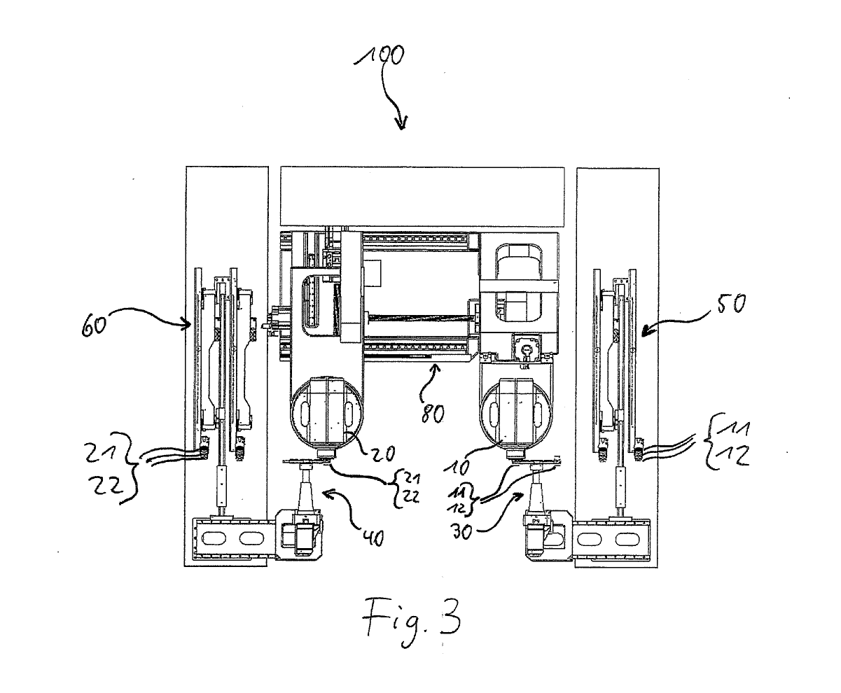

FIG. 3 shows, by way of diagram, the machine tool 100 with two wheel magazines 50 and 60 and two double grippers 30 and 40 in a basic position of the work spindles 10 and 20.

The basic position here shown is simultaneously the position of the work spindles 10 and 20 when they interact with the double grippers 30 and 40 and a change of the clamping or support means 11 or 21 takes place at the corresponding work spindle 10 or 20.

It is an advantage if, in the illustrated basic position of the work spindles 10 and 20, the clamping and support means 11 and 21 which are to be introduced and which are stored in the magazines 50 and 60, are positioned at the handover position from magazine to double gripper in parallel to the clamping and support means 11 and 21, which are removed by the double grippers 30 and 40 from the spindle heads of the work spindles 10 and 20. This promotes a particularly fast change of the clamping and support means 11 and 21 since the double grippers 30 and 40 have to travel shorter travels to correspondingly remove the clamping or support means 11 and 21 from the magazines 50 and 60 and to supply them to the work spindles 10 and 20 or remove them from the work spindles 10 and 20 and supply them to the magazines 50 and 60.

It is also an advantage if the clamping and support means 11 and 21 which are to be introduced and which are stored in the magazines 50 and 60 are disposed at the handover position of magazine to double gripper and, in addition, lie in the same horizontal plane in which the clamping and support means 11 and 21 are disposed when they are removed by the double grippers 30 and 40 from the spindle heads of the work spindles 10 and 20. As a result, further travels of the double grippers 30 and 40 can be dispensed with and the process of supplying and/or changing the clamping and support means 11 and 21 can be carried out more rapidly.

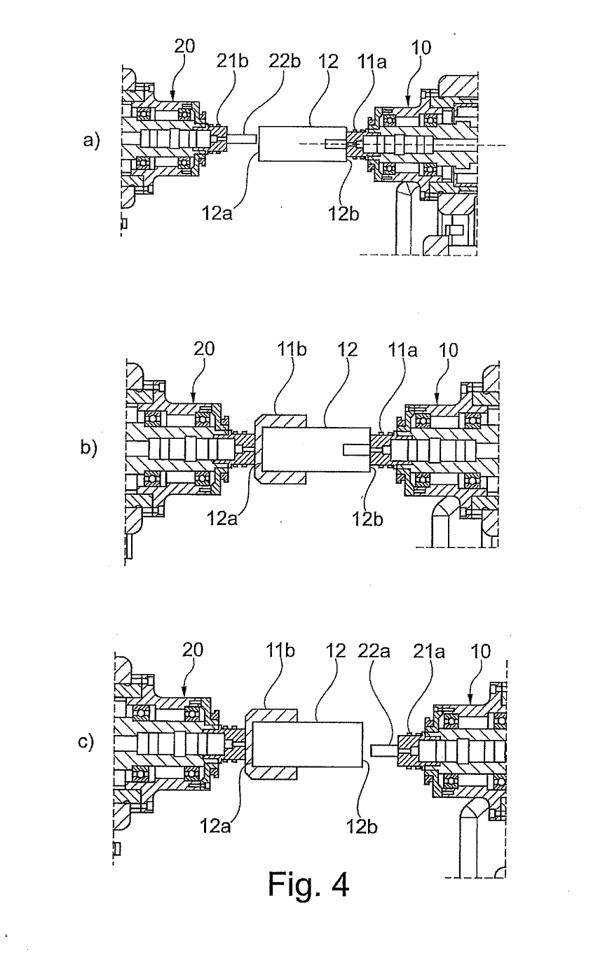

FIG. 4 shows, by way of diagram, the handover of a workpiece 12 between a first spindle 10 and a second spindle 20 according to an embodiment of the method according to the invention.

Partial image a) shows that the first work spindle 10 holds a clamping means 11a (in this example an internal clamping means) that carries a workpiece 12 which is held on a second side 12b by the clamping means 11a. Furthermore, the second work spindle 20 is shown which holds a support means 21b with a tool 22b.

This can be a situation in which the tool 22b processes or has processed the workpiece 12 on a first side 12a.

Partial image b) now shows how the support means 21b was exchanged with the tool 22b on the second work spindle 20 and that a clamping means 11b was introduced in exchange (in this example an external clamping means). Here, the clamping means 11b holds the workpiece 12 on the first side 12a.

For the sake of completeness, it should be noted that holding the workpiece 12 on the first side 12a in the example as shown is only possible since the work spindles 10 and 20 have adopted a coaxial alignment in relation to each other in advance and the work spindles 10 and 20 were positioned in relation to each other along the common spindle axis direction.

Partial image c) now shows that the clamping means 11a was exchanged at the first work spindle with a support means 21a with tool 22a and the second side 12b of the workpiece 12 can now be processed with the tool 22a.

The illustrated and described handover process shall clarify how flexible the interaction between the two work spindles 10 and 20 can be to be able to process a workpiece 12 from all sides without the workpiece 12 having to be re-clamped manually with the known drawbacks.

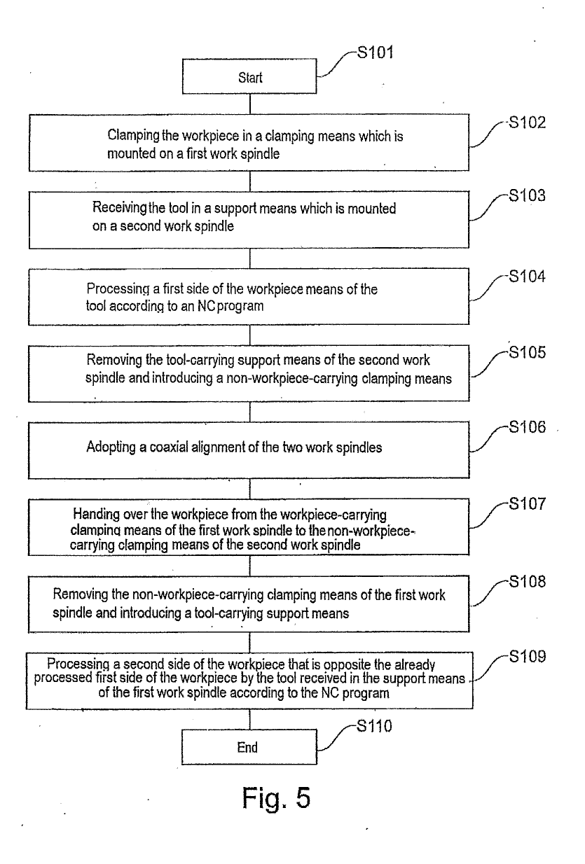

FIG. 5 shows a flow diagram of an embodiment of the method according to the invention. FIG. 4 shall additionally be considered as a support for the description of the method.

In step S102, the workpiece 12 is clamped on a second side 12b in a clamping means 11a, which is mounted on a first work spindle 10. Here, the clamping means can be e.g. an internal clamping means (as shown in FIG. 4).

In the next step S103, a tool 22b is received in a support means 21b, which is mounted on a second work spindle 20. A milling tool, e.g. a shank cutter, can be used as an example of a tool 22b (as shown in FIG. 4).

In the following step S104, a first side 12a of the workpiece 12 is now processed by means of the tool 22b according to an NC program. Here, further sides of the workpiece 12 can also be processed, such as the lateral surface of the workpiece 12, which is disposed between the first side 12a and the second side 12b.

After the processing of the first side 12a of the workpiece 12 by the tool 22b, the support means 21b is exchanged, in step S105, with the tool 22b of the second work spindle 20 and a non-workpiece-carrying clamping means 11b is introduced e.g. by means of a manipulator, which is designed e.g. as a double gripper. Here, e.g. an external clamping means (as shown in FIG. 4) can be used.

As a result of the introduction of the clamping means 11b, the workpiece 12 can now be held basically by the clamping means 11b. However, in order to supply the workpiece 12 to the clamping means 11b, the two work spindles 10 and 20 have to be coaxially aligned in relation to each other in step S106. This is an extremely important step since a handover of the workpiece 12 is only possible to a limited extent without the coaxial alignment of the work spindles 10 and 20 in the example shown in FIG. 4.

For example, an additional supply device/handover device can alternatively be provided between the work spindles 10 and 20, which compensates for a non-coaxial alignment of the work spindles 10 and 20. However, a possible additional supply device/handover device shall be discussed later.

After the coaxial alignment, the workpiece 12 can be handed over from the workpiece-carrying clamping means 11a of the first work spindle 10 to the non-workpiece-carrying clamping means 11b of the second work spindle 20 in the following step S107, in which the work spindles 10 and 20 are positioned in relation to each other along their common, coaxially aligned spindle axis direction.

Then, the clamping means 11a of the first work spindle 10 can be retracted and exchanged in step S108. A support means 21a with a tool 22a (e.g. again a shank cutter or the like) can be introduced instead, as shown in FIG. 4.

Then, in a subsequent step, S109, the second side 12b of the workpiece 12, which is opposite the already processed first side 12a of the workpiece 12, can be processed according to the NC program with the introduced tool 22a of the first work spindle 10.

Since it is possible to hand over a workpiece 12 inside the machine tool 100 from one work spindle to the next, processing procedures can largely be processed in fully automatic fashion. Furthermore, it is extremely advantageous that all sides of a workpiece 12 can be processed in a single processing procedure without the workpiece 12 in the machine tool 100 having to be re-clamped manually by a skilled worker or machine operator. This saves time and reference points of the machine tool 100 on the workpiece 12 are not lost, such that it is not necessary to set up the machine tool 100 again.

The method can be extended to the effect that even before the step S106 (coaxial alignment of the work spindles 10 and 20 in relation to one another) the work spindles 10 and 20 adopt a basic position in which the spindle axes of the work spindles 10 and 20 lie in a plane, as shown e.g. in FIG. 3. Here, the basic position as shown is simultaneously the position in which the work spindles 10 and 20 can interact with the manipulators or double grippers 30 and 40.

The work spindles 10 and 20 can then be rotated out of the basic position by a rotary motion about a respective rotational axis, which are perpendicular to the plane, up to a coaxial alignment of the spindle axes. Following this, the method could then be continued with step S106.

The workpiece 12 can preferably be handed over from the first work spindle 10 to the second work spindle 20 in the method in such a way that during the handover the two work spindles 10 and 20 are simultaneously in contact with the workpiece 12, as shown in FIG. 4 by way of example. This would render an additional supply device/handover device superfluous.

However, the method is not limited thereto. The method can rather be extended to the effect that an additional supply device/handover device, e.g. an additional manipulator/double gripper, is provided for the handover of the workpiece 12 from the first work spindle 10 to the second work spindle 20. The additional supply device/handover device might be designed in such a way that it compensates for a possible non-coaxial alignment of the work spindles 10 and 20 in relation to one another when the workpiece 12 is handed over from one work spindle to the other.

However, it can also be an advantage for a manipulator or double gripper 30 or 40 (see e.g. FIGS. 2 and 3) already present in the machine tool 100 to be designed in such a way that in addition to the interaction of magazine 50 or 60 and work spindle 10 or 20 it can also operate between the two work spindles 10 and 20.

This would also make an additional supply device/handover device superfluous and increase the flexibility of the machine tool 100.

Examples or embodiments of the present invention and the advantages thereof have been described above in detail with reference to the enclosed drawings

### LIST OF REFERENCE SIGNS

10 first work spindle
11, 11a, 11b clamping means
12 workpiece
12a first side of the workpiece
12b second side of the workpiece
20 second work spindle
21, 21a, 21b support means
22, 22a, 22b tool
30, 40 manipulator/double gripper
50, 60 magazine/wheel magazine
80 machine bed
100 machine tool

1. A machine tool for machining a workpiece by means of a tool, wherein the machine tool comprises a clamping means for clamping the workpiece and a support means for receiving the tool,
characterized in that
the clamping means is mounted on a spindle head of a clamping means-carrying work spindle, and the support means is mounted on a spindle head of a support means-carrying work spindle, and
the machine tool is designed to position the two work spindles in relation to one another by means of numerically controllable axes in such a way that the workpiece clamped in the clamping means can be processed by the tool received in the support means.

2. The machine tool according to claim 1, characterized in that the two work spindles are designed to carry both a support means for receiving a tool and a clamping means for clamping a workpiece.

3. The machine tool according to claim 1, characterized in that each of the two work spindles can be positioned in relation to one another by at least one rotational axis and at least one linear axis.

4. The machine tool according to claim 3, characterized in that a first of the two work spindles can be positioned about a first rotational axis and along a first linear axis in relation to the second of the two work spindles, and the second work spindle can be positioned about a second rotational axis which runs parallel to the first rotational axis and along a second linear axis and a third linear axis, which run both perpendicularly to one another and perpendicularly to the first linear axis.

5. The machine tool according to claim 1, characterized in that the two work spindles are designed to adopt a basic position in which the spindle axes lie in one plane, wherein, proceeding from the basic position, a coaxial arrangement of the two working spindles can be achieved by positioning the work spindles in relation to one another just by a rotary motion about a respective rotational axis perpendicular to the plane.

6. The machine tool according to claim 1, characterized in that the machine tool also has a manipulator, which is designed to introduce and exchange, at the two work spindles, both the workpiece-carrying and/or non-workpiece-carrying clamping means and the tool-carrying and/or non-tool-carrying support means.

7. The machine tool according to claim 6, characterized in that the machine tool also has a magazine that is designed to place down workpiece-carrying and non-workpiece-carrying clamping means as well as to place down tool-carrying and non-tool-carrying support means, wherein the manipulator is also designed to remove the respective clamping or support means from the magazine.

8. The machine tool according to claim 7, characterized in that the machine tool has two magazines which are designed to place down workpiece-carrying and non-workpiece-carrying clamping means as well as to place down tool-carrying and non-tool-carrying support means, and has one or two manipulators which are designed to introduce and exchange workpiece-carrying and/or non-workpiece-carrying clamping means and tool-carrying and/or non-tool-carrying support means at the work spindles.

9. The machine tool according to claim 8, characterized in that the magazines are designed as wheel magazines and the manipulators are designed as double grippers.

10. The machine tool according to claim 1, characterized in that the spindle axis of the work spindles is disposed horizontally.

11. The machine tool according to claim 10, characterized in that a first of the two work spindles is arranged on a console at the machine bed and the second of the two work spindles is arranged on the machine bed in such a way that it is guided on a cross table.

12. The machine tool according to claim 1, characterized in that the clamping means is an external clamping means or an internal clamping means.

13. A method for machining a workpiece by means of a tool in a machine tool according to claim 1, the method comprising the following steps:
clamping the workpiece in a clamping means which is mounted on a first work spindle,
receiving the tool in a support means which is mounted on a second work spindle,
processing a first side of the workpiece by means of the tool according to an NC program.

14. The method according to claim 13, characterized by the following step:
exchanging the tool-carrying support means of the second work spindle and introducing a non-workpiece-carrying clamping means.

15. The method according to claim 14, characterized by the following step:
transferring the workpiece from the workpiece-carrying clamping means of the first work spindle to the non-workpiece-carrying clamping means of the second work spindle.

16. The method according to claim 15, characterized by the following steps:
exchanging the non-workpiece-carrying clamping means of the first work spindle and introducing a tool-carrying support means,
processing a second side of the workpiece, which is opposite the already processed first side of the workpiece, by means of the tool which is received in the support means of the first work spindle, according to the NC program.

17. The method according to claim 15, characterized in that the two work spindles adopt a coaxial arrangement in relation to one another before handing over the workpiece from the first work spindle to the second work spindle.

18. The method according to claim 17, characterized in that the following steps are carried out before the two work spindles adopt the coaxial arrangement:
adopting a basic position, in which the spindle axes lie in one plane, and
rotating one of the two work spindles about a respective rotational axis perpendicular to the plane up to a coaxial alignment of the spindle axes of the two work spindles.

19. The method according to claim 15, characterized in that the workpiece is handed over from the first work spindle to the second work spindle in such a way that during the handover the two work spindles are in contact with the workpiece.

20. The method according to claim 15, characterized in that the workpiece is handed over from the first work spindle to the second work spindle by means of a manipulator.
